(19) United States
(12) Patent Application Publication
(10) Pub. No.: US 2005/0117229 A1
(43) Pub. Date: Jun. 2, 2005

(54) [Disposable Magnifying Reader and Container]

(76) Inventor: Mark C. Block, Estes Park, CO (US)

Correspondence Address: MARK C. BLOCK, P.O. BOX 1721, ESTES PARK, CO, 80517, US

(21) Appl. No.: 10/707,137

(22) Filed: Nov. 21, 2003

(51) Int. Cl. G02B 27/02

(52) U.S. Cl. 359/802

(57) ABSTRACT

A disposable flat-sheet wallet-sized magnifying lens to read indicia such as but not limited to a menu, wine list or desert list that is inserted into a self-adhesive container pocket attached to the menu and or list; and made of plastic, vinyl or other promotional material suitable for its intended use. The magnifying lens is a complementary promotional advertising piece provided by the business, restaurant, bar, casino or establishment to be presently utilized and taken with the customer upon departure.

### BACKGROUND OF INVENTION

This invention is directed to 3 parts. 1.) a disposable flat sheet-type wallet-size magnifying lens permitting magnification of difficult to read indicia in booklets/reading material such as but not limited to restaurant menus, wine lists and desert lists, hereto referred to as “menu”. 2.) a self adhesive container pocket that can be attached to the menu, hereto referred to as “pocket” that will house the magnifying lens 3.) an advertising medium to be utilized by a business or enterprise such as but not limited to a restaurant, bar, casino or establishment hereto referred as “restaurant”.

Demographics indicate the masses of today's population is aging in increasing numbers. Because of this, more of our population is in need of visual aids, such as reading glasses to assist them in reading the indicia. Many of today's population resists this aging process by refusing to obtain or utilize “obvious to the public” corrective lens.

Magnifying lens are previously known art. They have historically been used to magnify indicia in obvious configurations, in multitude of designs encompassed by others for the delivery of many goals and objectives.

By way of example U.S. Pat. No. 5,760,975 to DiGiovanni reveals a device for magnification end cap for bottles.

U.S. Pat. No. 4,819,351 to Boitani discloses a book-like folder for guided menus that provides a magnifying lens on a chain to secure the lens to the menu.

U.S. Pat. No. 6,532,117 to Taylor shows tableware magnifier to read menus that is part of a table service such as a plate remaining with the restaurant.

U.S. Pat. No. 5,617,70 and U.S. Pat. No. 5,471,347 to Galiani reveals a magnifying container for printed mater again with the lens interconnected to the menu to prevent separation.

U.S. Pat. No. 5,333,907 to Schaeffer discloses a combination book with magnifying page insert attached to the book covers to assist in reading indicia. The magnifying insert is permanently attached.

In today's competitive world it becomes increasingly evident of the importance for a business or establishment to keep their name in front of their customer. This has been done through advertising and promotional ways including the printing of the business name, logo and designs on items such as matchbooks, coasters, glassware, plasticware and the like. This invention achieves this goal by promoting the customer to take with them the magnifying lens with the business advertising information printed on it; for future use not only in other restaurants, but to assist reading in the home, in meetings, and reading other indicia in the customer's daily lives.

### SUMMARY OF INVENTION

It is the principal feature of this invention to provide a novel advertising and promotional item for a business or establishment that will continually keep their name in front of the customer.

It is another feature of this invention to provide a value-added service by the business or establishment to their customers utilizing a magnifying lens to assist in reading the indicia on the “menu”.

It is also the feature of this invention to provide an inconspicuous disposable wallet-sized magnifying visual-aid to the demographics requiring this type of assistance.

The features of the present invention are realized through the use of a completely removable flat sheet wallet size lens such as a Fresnel lens that easily slides inside and out of the self-adhesive container pocket. The container pocket can be easily attached in any convenient spot on the menu. The container pocket identifies the magnifying lens. Once removed by the customer for use, the Business promotional indicia is printed around the peripheral boundaries of the lens indicating it is a complementary item for the customer to use and take with them upon their departure.

Although the present invention is described as a flat sheet, wallet sized lens such as a Fresnel lens for magnification of indicia, this invention is not intended to be limited in any manner what so ever by the recitation of any particular lens structure or dimension. The scope of this invention is intended to use any lens and or container pocket material suitable for the intended purpose.

### BRIEF DESCRIPTION OF DRAWINGS

FIG. 1. (PA280025.tif) is a perspective front view of a self-adhesive container pocket which will hold the magnifying glass with no indicia currently printed on the pocket.

FIG. 2. (PA280024.tif) is a perspective front view of the magnifying lens with no indicia made in accordance with the present invention.

FIG. 3. (PA280023.tif) is a side view of the magnifying lens with no indicia made in accordance with the present invention.

FIG. 4. (PA280035.tif) is a side view of the self-adhesive container pocket with no indicia which will hold the magnifying lens made in accordance with the present invention.

FIG. 5. (PA280028.tif) is a diagonal perspective view of the magnifying lens inserted into the self-adhesive container pocket with no indicia made in accordance with the present invention.

FIG. 6. (PA280030.tif) is a frontal perspective view of the magnifying lens inserted into the self-adhesive container pocket with no indicia made in accordance with the present invention.

FIG. 7. (PA280031.tif) is a side view of the magnifying lens inside the self adhesive container pocket with no indicia made in accordance with the present invention.

FIG. 8. (PA280022.tif) is a diagonal perspective view of the magnifying lens with no indicia made in accordance with the present invention.

FIG. 9. (PA280005.tif) is a frontal view of the magnifying lens with indicia made in accordance with the present invention.

FIG. 10. (PA280007.tif) is a frontal view of the magnifying lens sliding into the container pocket with indicia made in accordance with the present invention.

FIG. 11. (PA280008.tif) is a side view of the magnifying lens inside the container pocket with indicia made in accordance with the present invention.

FIG. 12. (PA280014.tif) is a diagonal perspective of the magnifying lens sliding into the container pocket with indicia made in accordance with the present invention.

FIG. 13. (PA28009.tif) is a diagonal perspective of the magnifying lens inside the container pocket with indicia made in accordance with the present invention.

FIG. 14. (PA280017.tif) is a side view of both the magnifying lens and the container pocket side by side with indicia made in accordance with the present invention.

FIG. 15. (PA280018.tif) is a diagonal view of both the magnifying lens and the container pocket side by side with indicia made in accordance with the present invention.

FIG. 16. (PA280019.tif) is a diagonal view of both the magnifying lens and the container pocket with no indicia made in accordance with the present invention.

FIG. 17. (PA280020.tif) is a side view of the magnifying lens and the container pocket with no indicia made in accordance with the present invention.

FIG. 18. (PA280021.tif) is a frontal perspective of both the magnifying lens and the pocket with no indicia made in accordance with the present invention.

### DETAILED DESCRIPTION

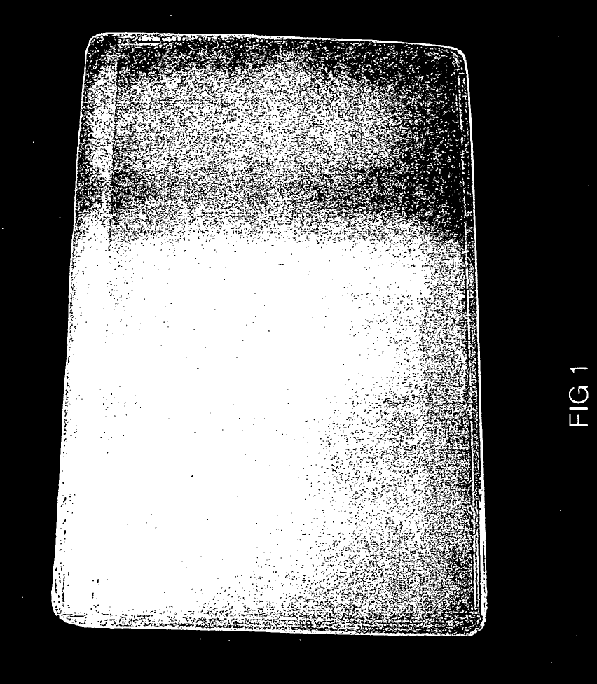

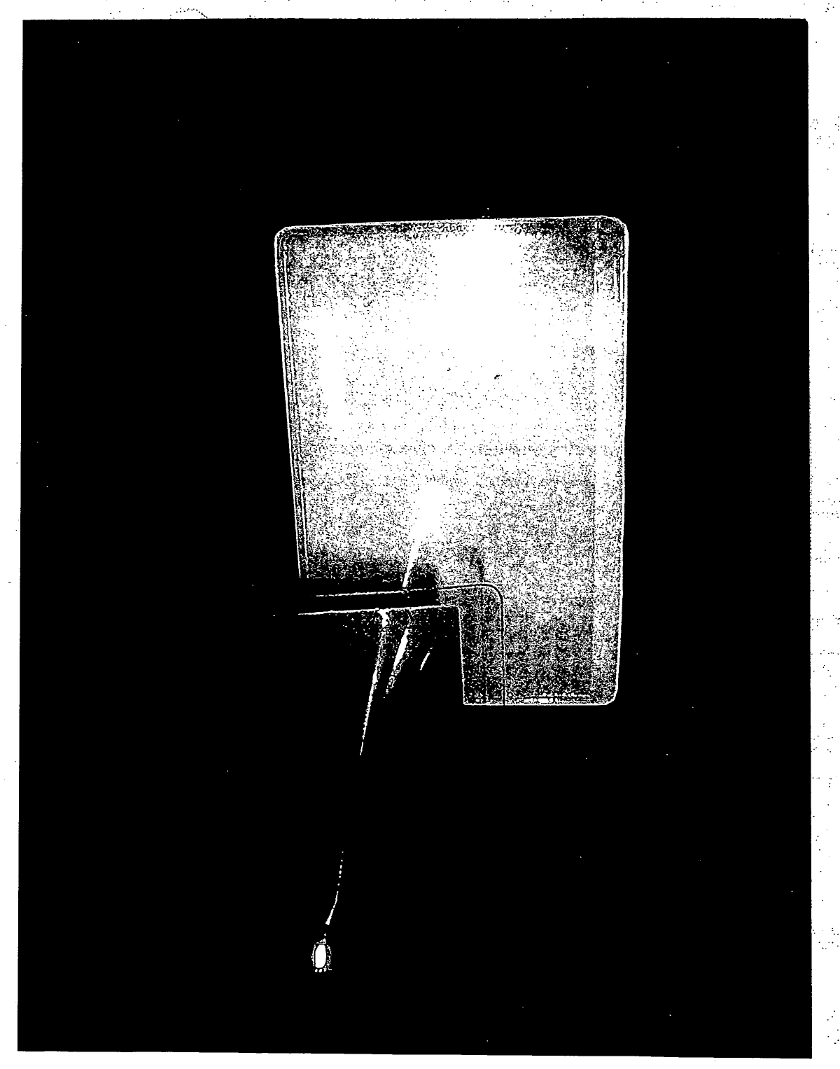

As can be seen in FIG. 1., the self adhesive container pocket consist of a three-sided sealed pocket with an opening at the top that will allow the easy slipping of the magnifying lens into an out of the pocket to be utilized by the customer. The back side of the pocket is self-adhesive allowing easy attachment to the menu with a simple peel away paper type backing. The front side of the pocket is a vinyl, plastic or other material-suitable cover allowing easy viewing of the actual magnifying lens housed inside of the container pocket. FIG. 4., shows a side view and the slim lined detailing of the pocket.

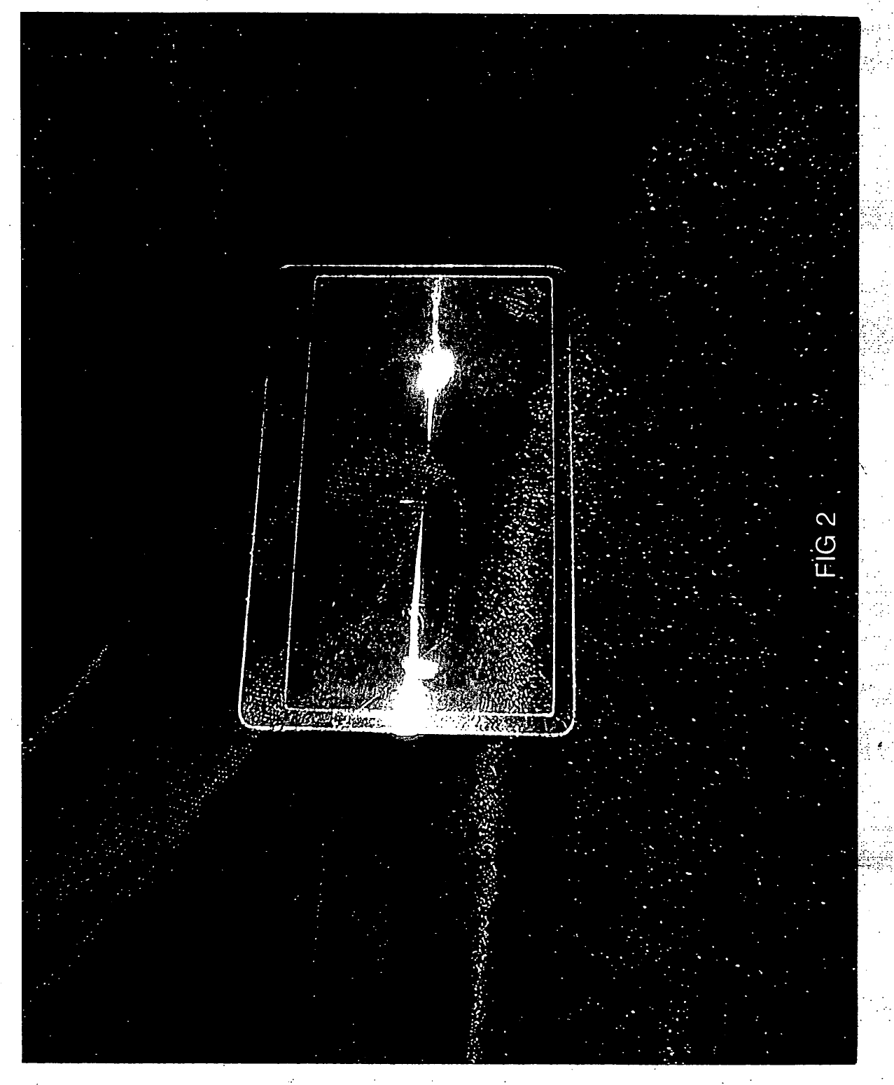

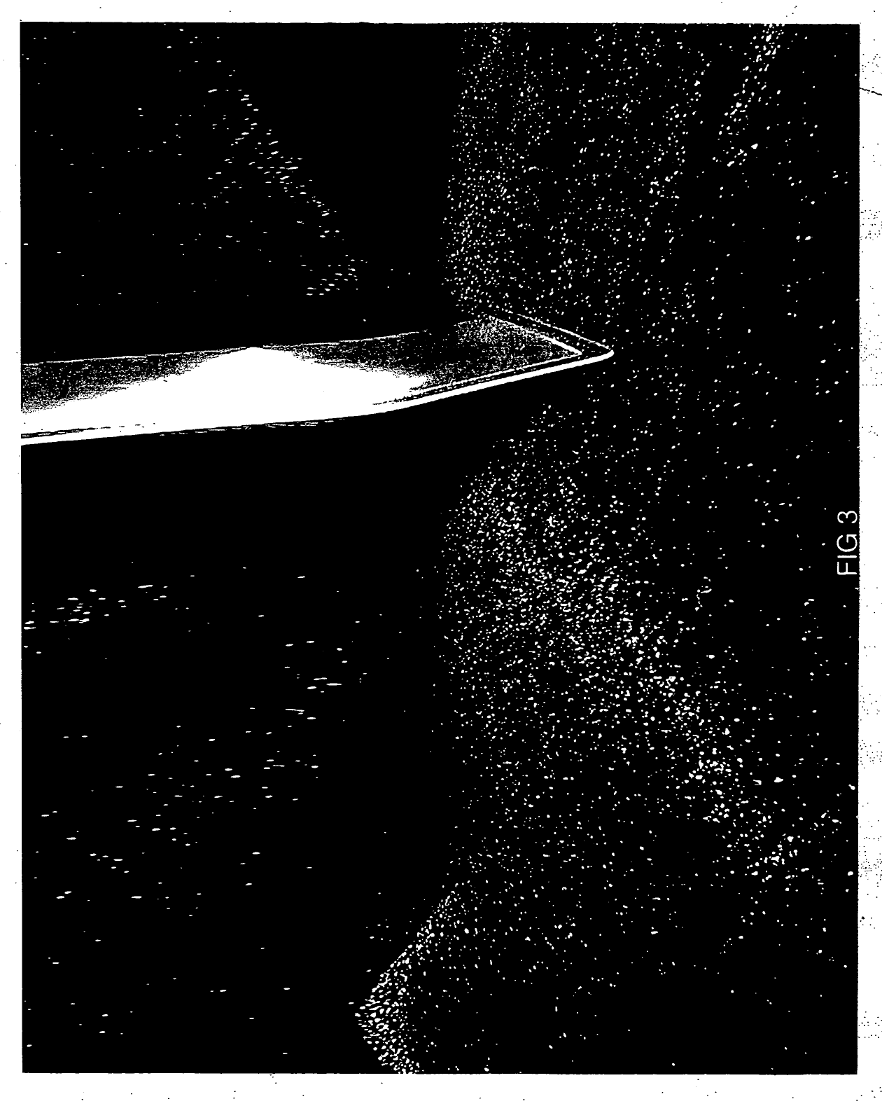

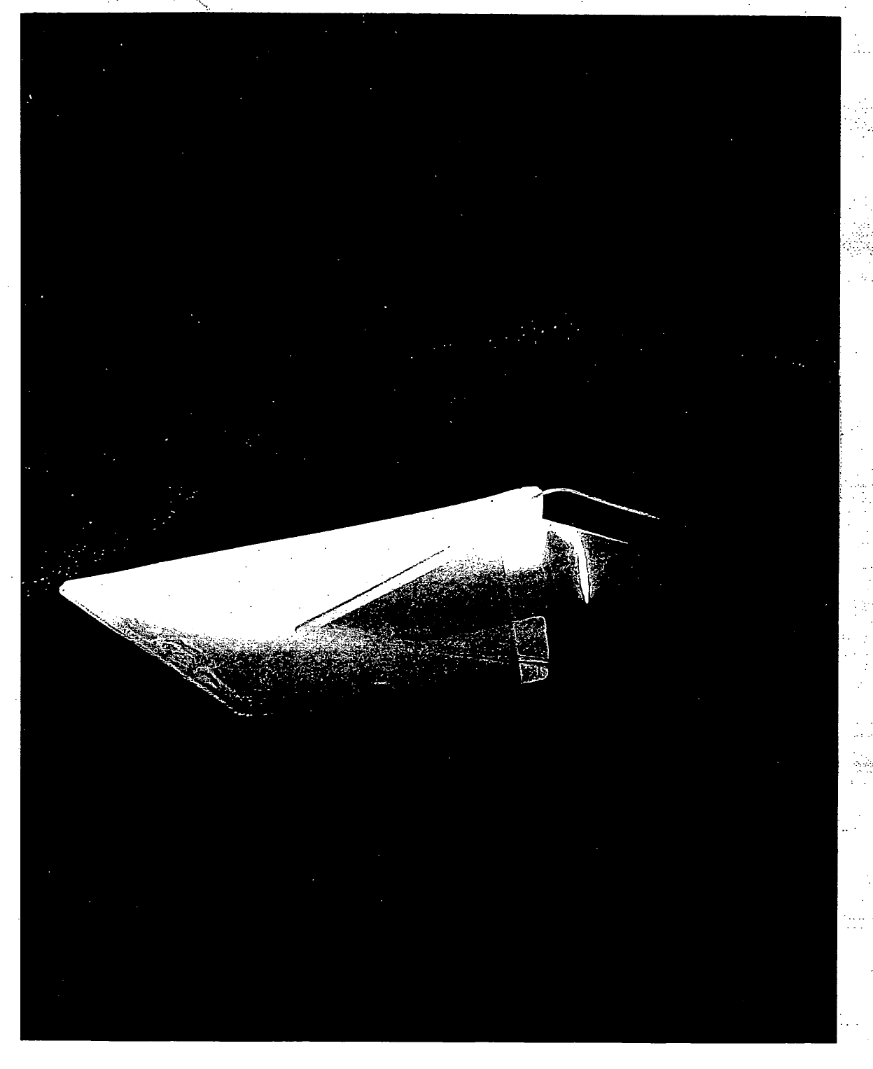

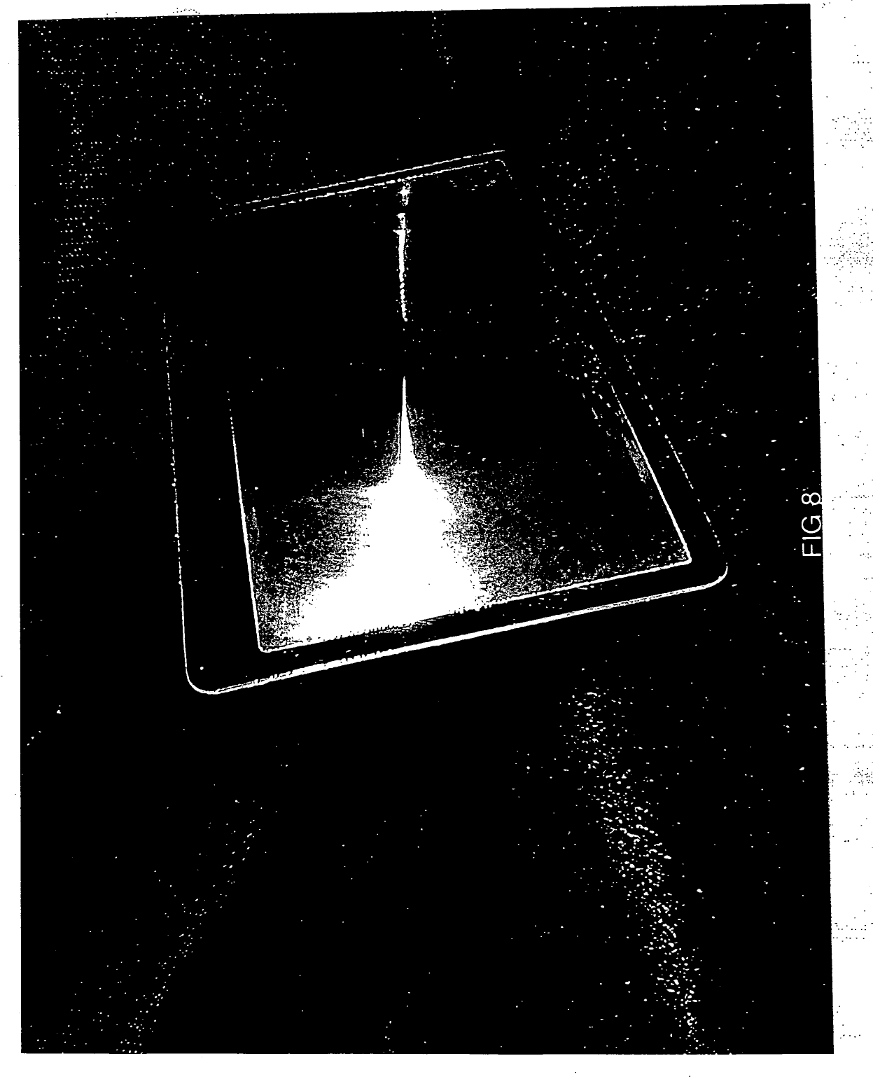

FIG. 2., shows the actual wallet-sized magnifying lens with present dimensions the size of a credit card. See FIG. 3 side view. and FIG. 5 and FIG. 8, diagonal view of the same. The lens, made in accordance with the present invention, currently is utilizing the Fresnel lens to accomplish the goals and objectives of an indiscriminate visual-aid to be utilized by the customers of the restaurant to read the fine print of the menu. The lens can then be easily slipped into the customer's wallet for repeated use at a later date as a complementary item from the restaurant, bar, casino or business establishment.

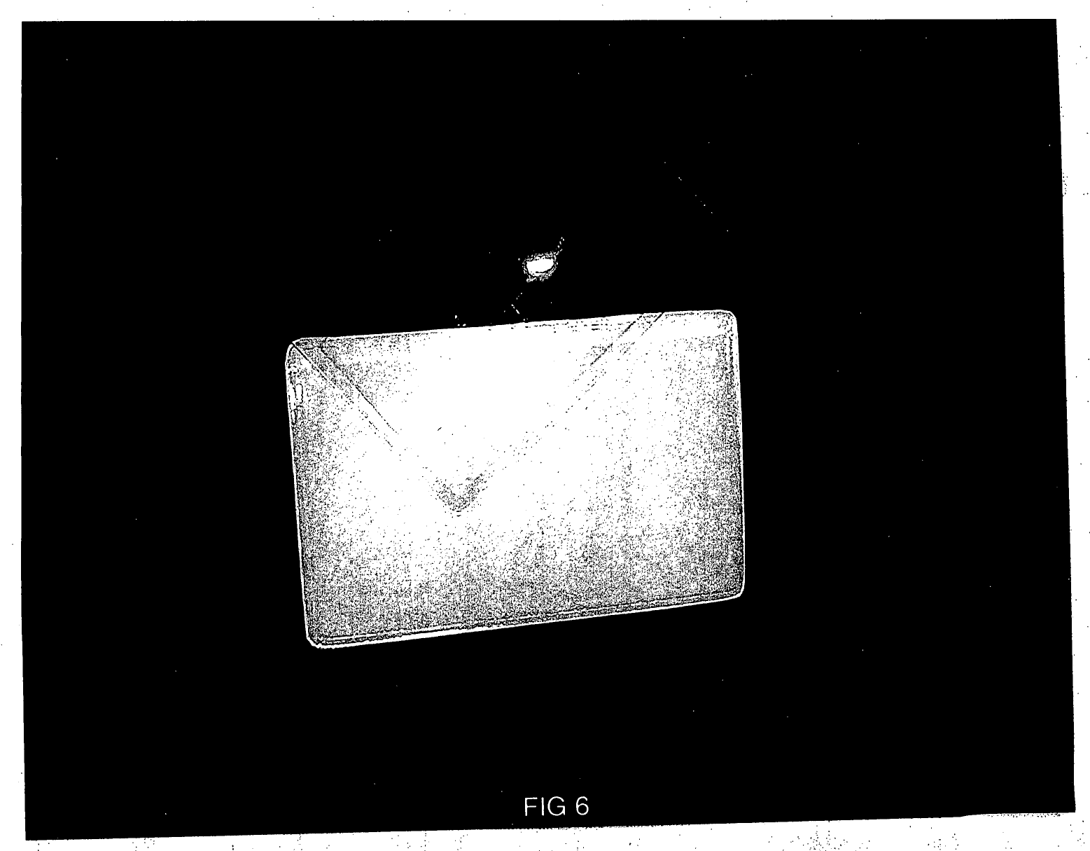

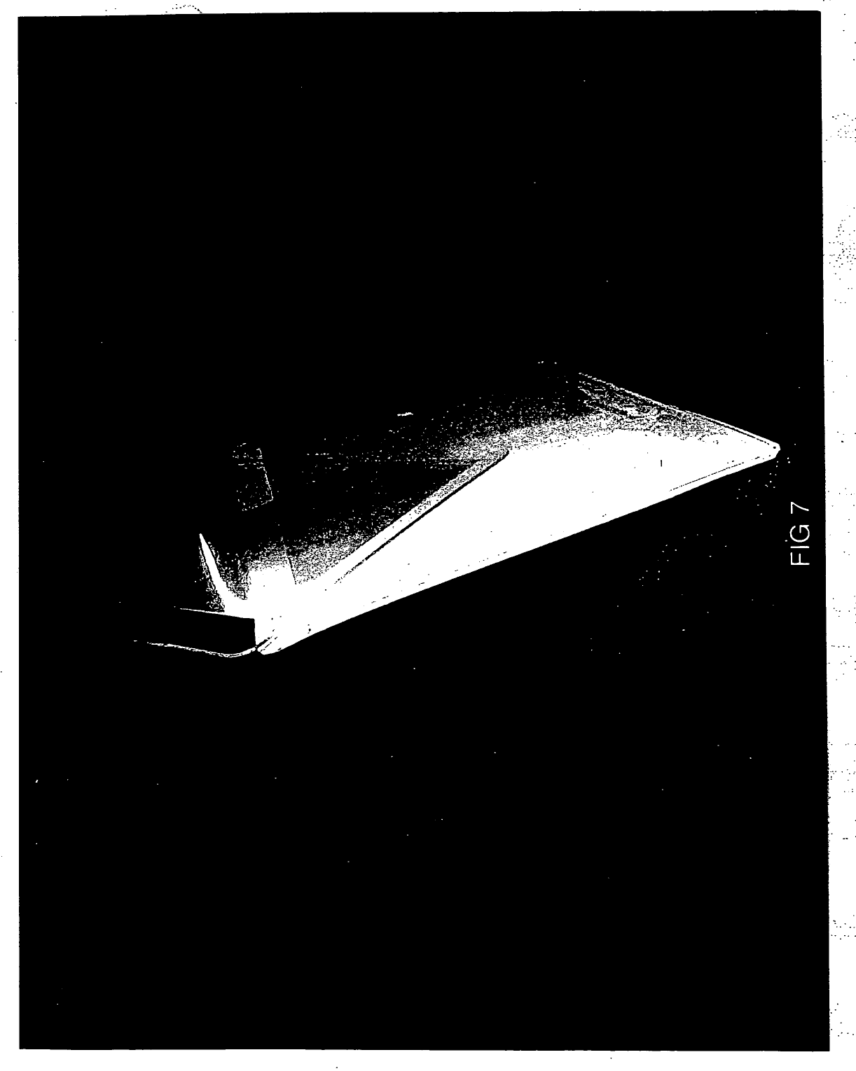

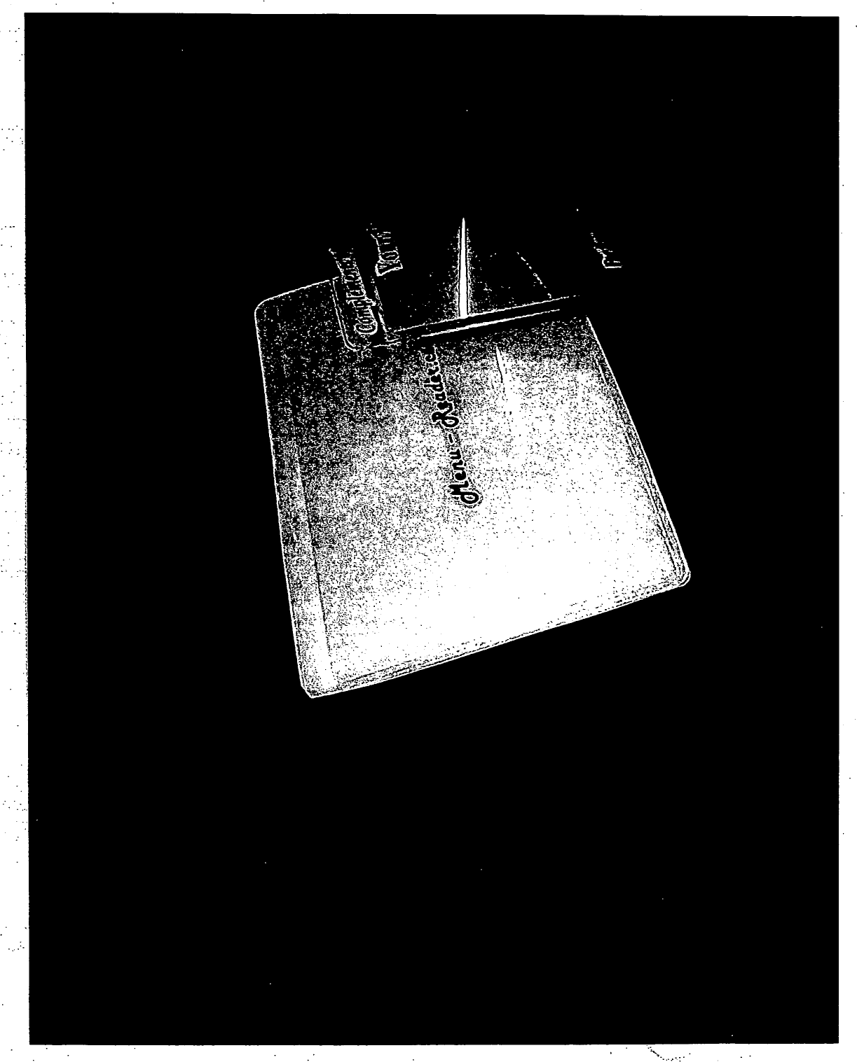

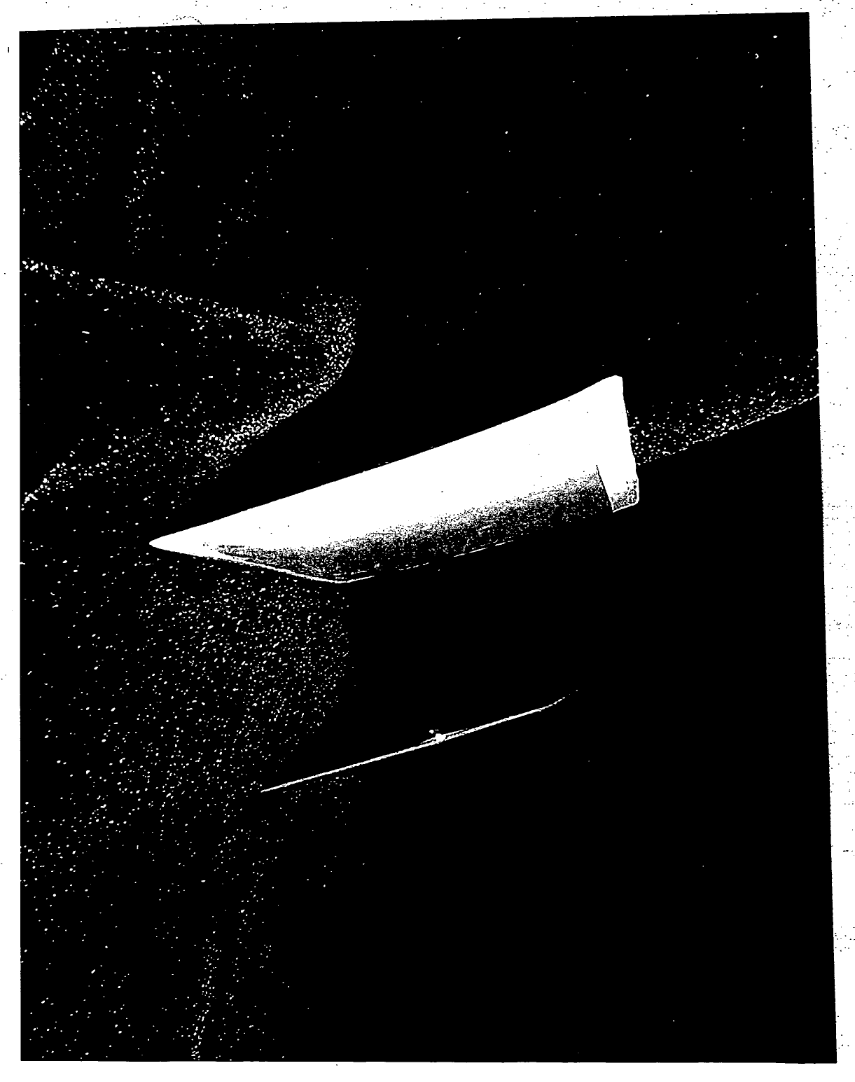

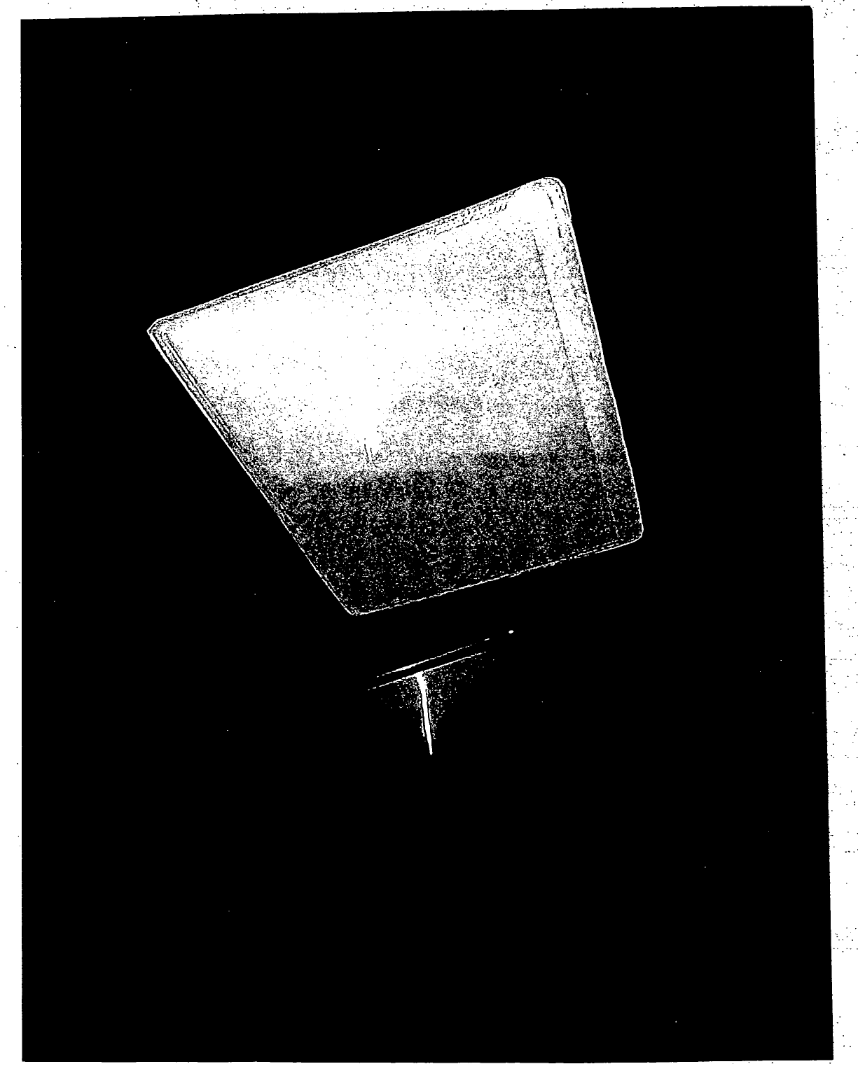

FIG. 6., FIG. 18., shows a frontal view and FIG. 7. and FIG. 17., shows a side view of the magnifying lens inserted into the self-adhesive container pocket. FIG. 16. is a diagonal view of both the magnifying lens and the container pocket.

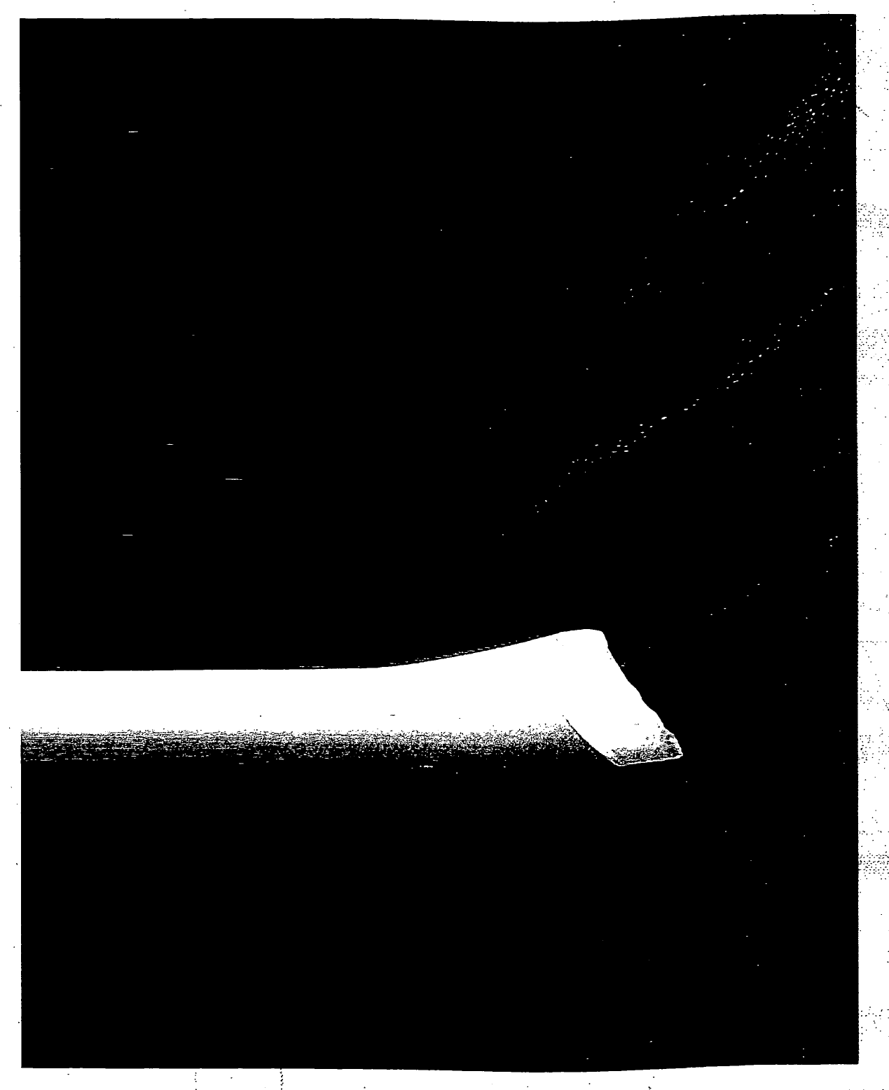

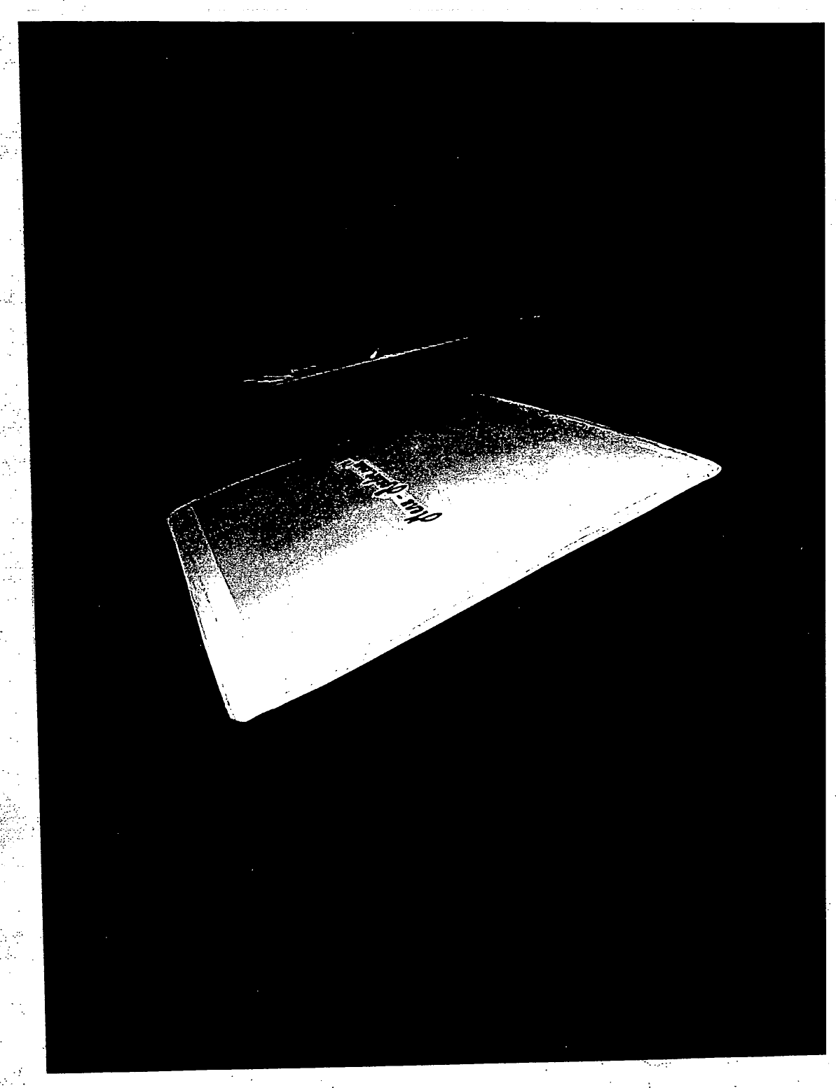

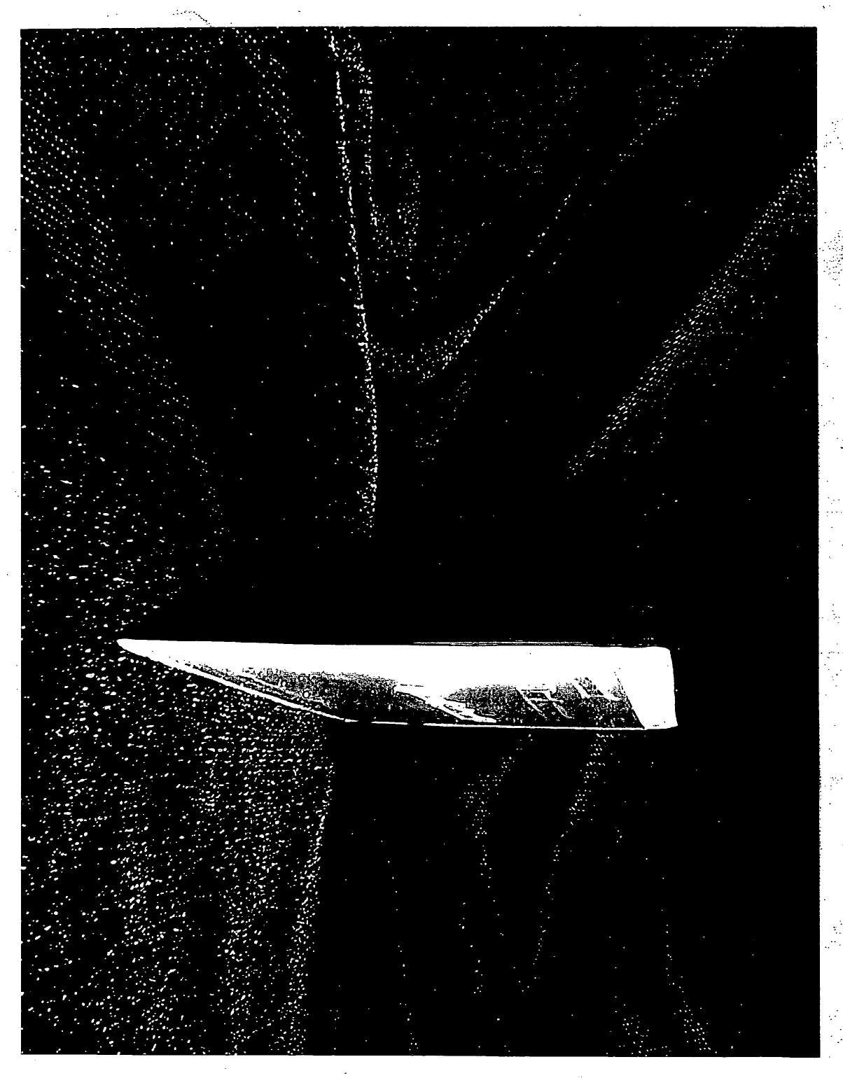

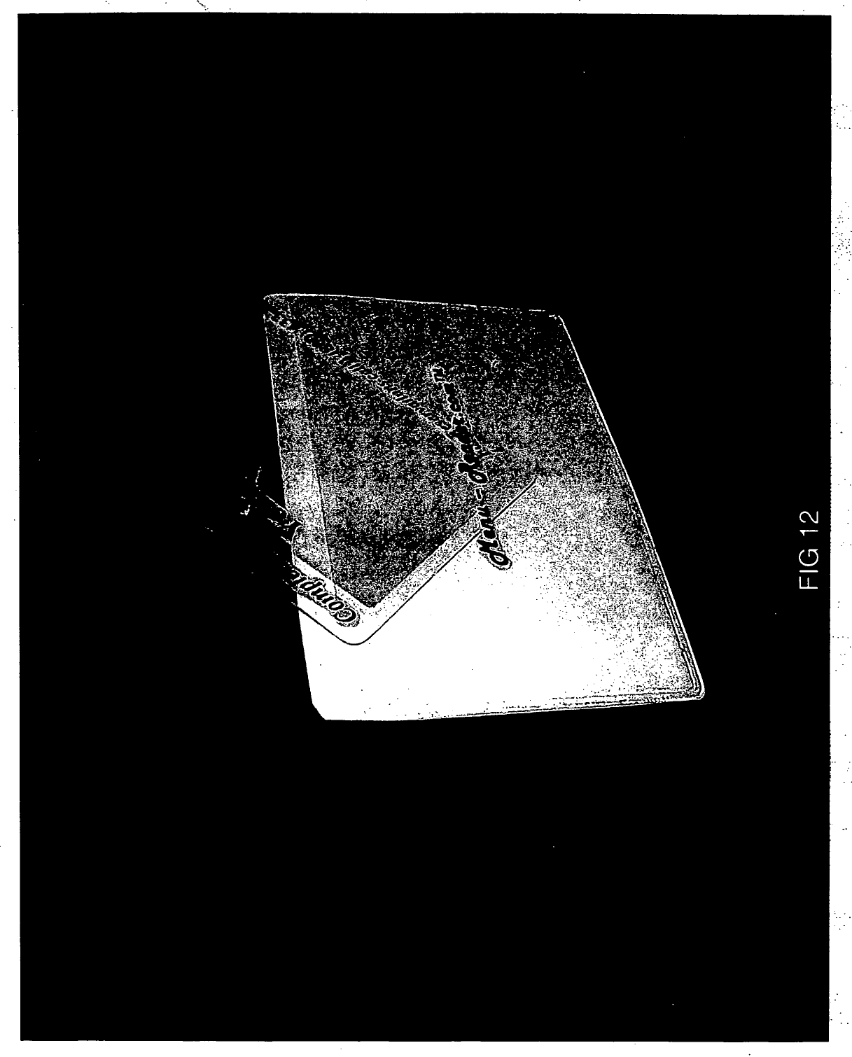

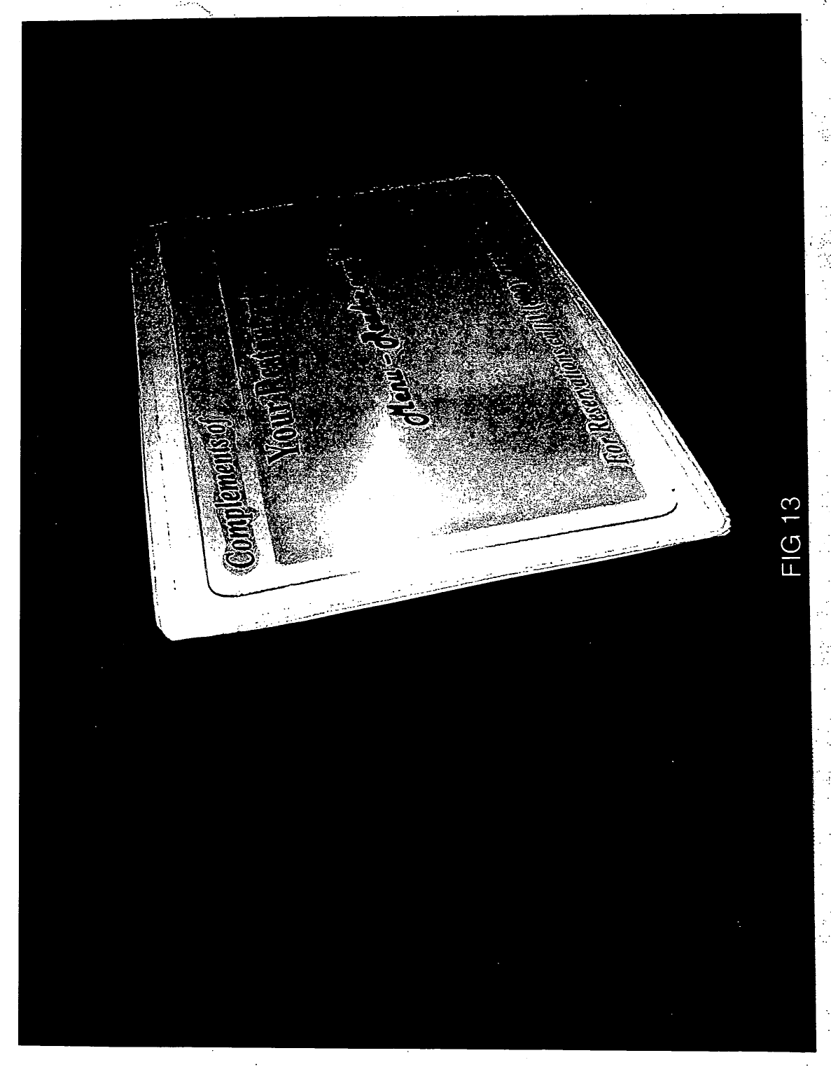

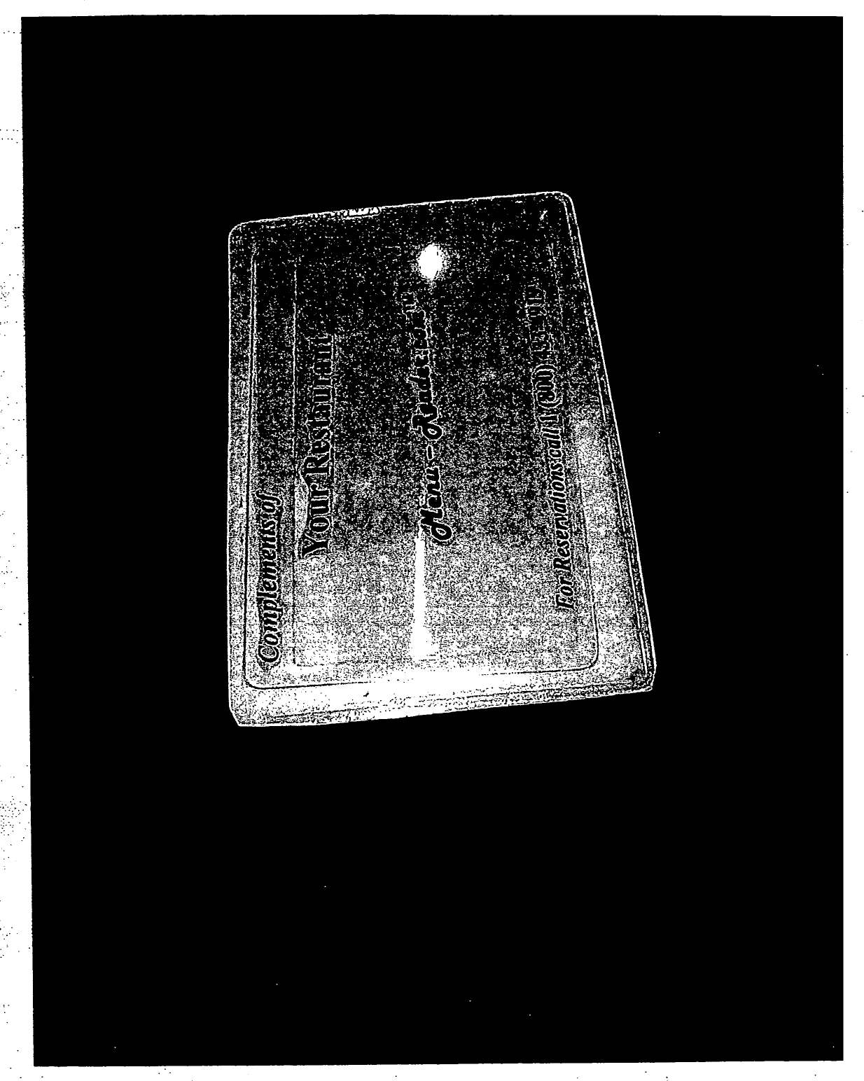

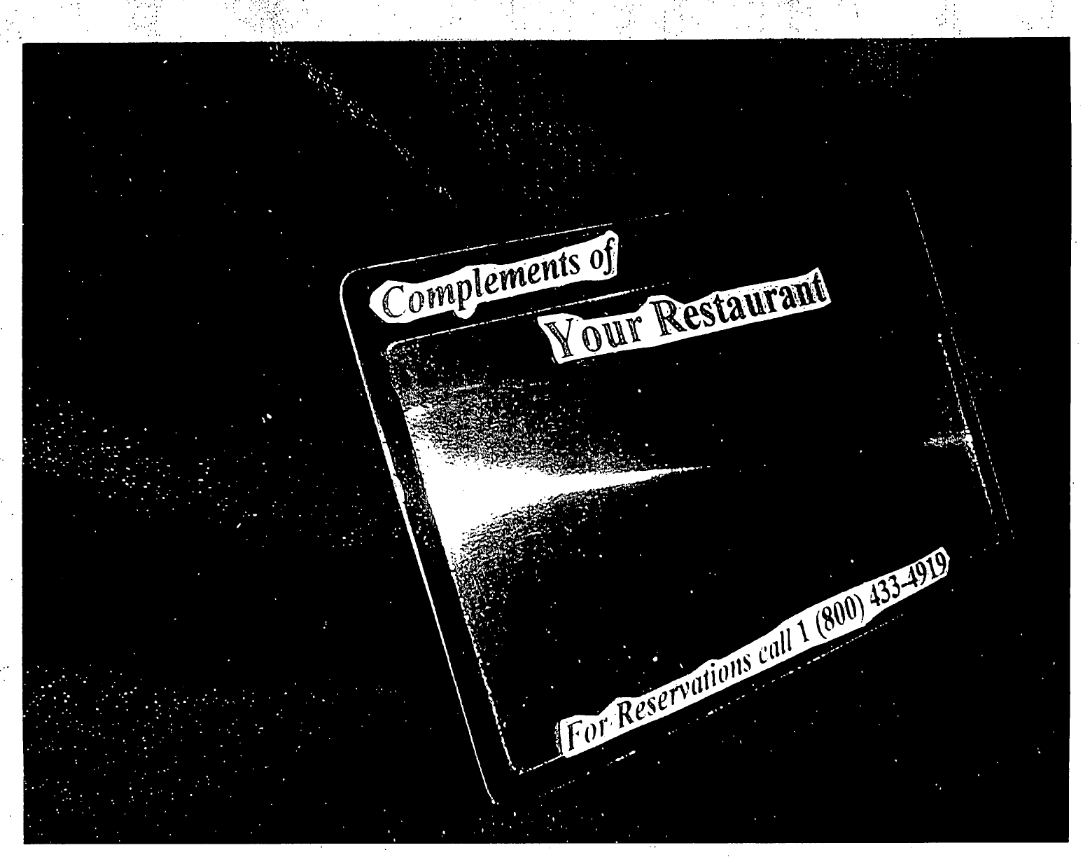

FIG. 9., FIG. 10., FIG. 11., FIG. 12., FIG. 13., FIG. 14., FIG. 15., all show different viewings with indicia reflected on both the pocket and the magnifying lens. The indicia on the pocket clearly identifies the contents of the container pocket. The indicia on the magnifying lens reflects promotional information such as but not limited to the lens is a complimentary item of the restaurant, the restaurant's name, logo and telephone number. It is the intent of the present invention to be utilized primarily as a promotional advertising piece of the restaurant that will be replaced as needed in the menus, while additional value-added service is provided to the customer for ease in reading the establishment's menu.

The current invention has been presented for illustrative but not for limitative purposes, and is to be accepted that modifications and or changes can be made in the same without departing from the spirit and scope of the invention for which a priority right is claimed.

1. A novel promotional and advertising item that a business or establishment may utilize to keep their name in front of the customer comprising of:
a.) a disposable flat-sheet wallet-sized magnifying lens with promotional indicia printed around the peripheral edges of the lens. This lens may be retained by the customer until scratched, worn or lost; and
b.) a self-adhesive pocket that can be conveniently attached to the menu to hold the magnifying lens and all future replacements. This pocket identifies to the customer of availability of the lens for the complementary present and future use.
